(19) United States
(12) Patent Application Publication
(10) Pub. No.: US 2010/0199678 A1
(43) Pub. Date: Aug. 12, 2010

(54) Corrosion-Resistant Pressure Vessel Steel Product, a Process for Producing It and a Gas Turbine Component

(76) Inventors: Claus Krusch, Mulheim an de Ruhr (DE); Werner Stamm, Mulheim an der Ruhr (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/678,157

(22) PCT Filed: Sep. 13, 2007
(86) PCT No.: PCT/EP07/07991

§ 371 Date: Mar. 15, 2010

(51) Int. Cl. F02C 1/00; B65D 85/00

(52) U.S. Cl. 60/752; 206/524.6

(57) ABSTRACT

A corrosion-resistant pressure vessel steel is provided. The corrosion-resistant pressure vessel is formed by aluminization of a pressure vessel steel and deliberate oxidation of the layer which has been enriched in this way. Also provided is a process for producing a corrosion-resistant pressure vessel product. The process includes alitizing the pressure vessel steel and then oxidizing the steel before it is used for the first time. Lastly, a gas turbine component using the pressure vessel steel product is provided.

### CROSS REFERENCE TO RELATED APPLICATIONS

This application is the US National Stage of International Application No. PCT/EP2007/007991, filed Sep. 13, 2007 and claims the benefit thereof.

### FIELD OF INVENTION

The invention relates to corrosion-resistant pressure vessel steels, in particular according to DIN EN 10028-2, to a process for producing them and to a gas turbine component.

### BACKGROUND OF INVENTION

Pressure vessel steels of this type are often used in steam boilers, in the construction of steam turbines and in chemical industry sectors. The operating temperatures are in the range of 300° C.-500° C. (temperature-resistant steel) or above 550° C.-800° C. (high-temperature-resistant steel).

However, when pressure vessel steels of this type are used, the corrosion and/or oxidation resistance is often low.

### SUMMARY OF INVENTION

Therefore, it is an object of the invention to specify a pressure vessel steel with improved corrosion properties and to specify new fields of application.

This object is achieved by pressure vessel steels as claimed in the claims, wherein, in a process as claimed in the claims, alitizing and/or chromizing take place in the surface region of the pressure vessel steel and finally controlled oxidation is carried out, and by a gas turbine component as claimed in the claims.

The dependent claims list further advantageous measures which can advantageously be combined arbitrarily with one another in order to obtain further advantages.

To date, it has not been customary to alitize pressure vessel steels.

### BRIEF DESCRIPTION OF THE DRAWINGS

In the drawings:

FIG. 1 shows a process for producing a corrosion-resistant pressure vessel steel product,

FIG. 2 shows a substrate with a weld location,

FIG. 3 shows a burner,

FIG. 4 is a perspective view of a gas turbine, and

FIG. 5 is a perspective view of a combustion chamber.

### DETAILED DESCRIPTION OF INVENTION

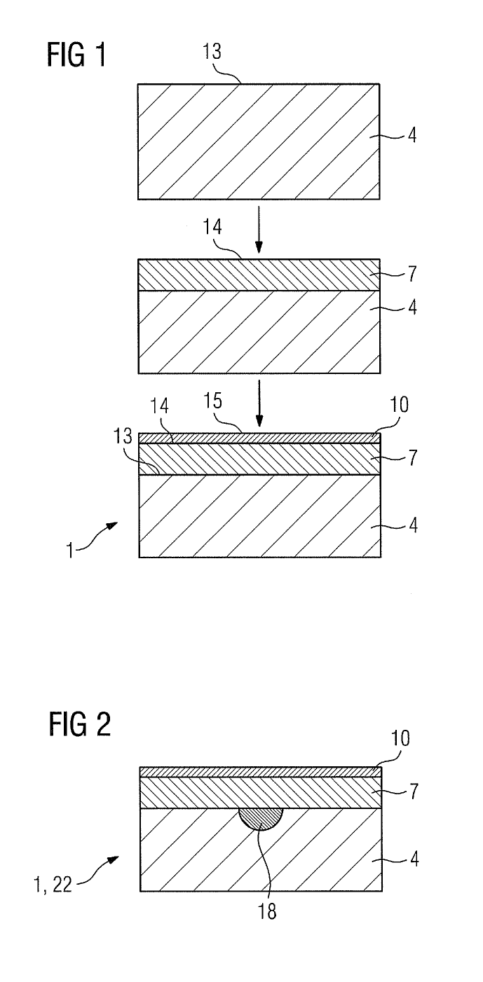

FIG. 1 schematically shows a process for producing a corrosion-resistant pressure vessel steel product 1 with a substrate 4.

The substrate 4 contains a pressure vessel steel.

A pressure vessel steel has better processability than nickel-based alloys. A disadvantage of nickel-based alloys having a significantly lower thermal conductivity than 16Mo3 is that of greater thermally induced stresses.

The pressure vessel steel present in the substrate 4 is iron, carbon, manganese, molybdenum and aluminum.

The substrate 4 preferably consists of iron, carbon, manganese, molybdenum and aluminum.

The substrate 4 may contain impurities such as silicon (≦0.35% by weight), phosphorus (≦0.035% by weight), sulfur (≦0.3% by weight) and/or copper (≦0.3% by weight), without excessively impairing the properties. The values between parentheses represent the maximum limits which are preferably to be used.

Depending on the alloy, it is desirable for the alloy of the substrate 4 not to contain silicon (Si), phosphorus (P), sulfur (S) and/or copper.

The term “the substrate “contains” means that the respective element is present markedly above the detection limit and/or the impurity level in a metallic alloy, in particular is at least

twice the detection limit or the impurity level, depending on which is higher.

16Mo3 is only one example of a temperature-resistant or high-temperature-resistant pressure vessel steel.

Further alloys which can be used with preference are PE235GH, PE265GH and also PG295GH, P355GH, 13CrMo4-5 and also 12CrMoV12-10. Molybdenum (Mo) is advantageously added, and this increases the temperature resistance and ensures a certain fine-grain nature.

16Mo3 has the following composition (in % by weight):

### C: 0.12-0.2

### Si: ≦0.35

### Mn: 0.4-0.9

### P: max. 0.035

### S: max. 0.3

### Cr: ≦0.3

### Mo: 0.25-0.35

### Cu: ≦0.3

remainder iron.

These alloys, in particular 16Mo3, may contain further alloying elements.

This is preferably chromium (Cr) in order to increase the temperature resistance.

It is preferably also possible to add vanadium (V), which increases the temperature resistance and ensures insensitivity toward superheating.

Si, Hf, Ce and/or Zr are preferably also added to the alloy for corrosion resistance.

The The pressure vessel steel is preferably used for a gas turbine component, in particular for a burner 22. If the substrate 4, as in the case of a gas turbine component 22, has a weld location 18 (FIG. 2), this is likewise alitized and/or chromized and the alitized and/or chromized region of the weld location 18 is oxidized.

Corrosion resistance tests have been carried out using sulfuric acid, and these show the superiority of the corrosion-resistant pressure vessel steel.

The substrate 4, preferably 16Mo3, is alitized (FIG. 1). In the process, aluminum passes onto the surface 13 of the substrate 4 and diffuses at least partially or completely into the substrate 4.

The aluminum or the chromium preferably diffuses completely into the substrate 4.

This can take place by various alitizing processes, such as, for example, CVD aluminizing or as disclosed in EP 1 298 230.

The thickness of the layer 7 enriched with aluminum is preferably 80 μm. Instead of aluminum, it is also possible to produce a chromium-rich layer or an aluminum- and chromium-rich layer 7 is particularly preferably produced.

The composition of the surface of the alitized and/or chromized layer 7 differs from that of the substrate.

It is also possible for a thin aluminum/chromium layer (overlay) to be formed.

In a last step, the enriched layer 7 is deliberately oxidized before it is used for the first time or before it is reused for the first time after refurbishment of the component 1, and therefore an aluminum oxide and/or chromium oxide layer 10 is formed on a surface 14 of the alitizing region with a surface 15.

upper limit is preferably 1% by weight.

In the event of chromizing, oxidation is not absolutely necessary since the desired chromium oxide is always formed.

In the event of alitizing, α-aluminum oxide (α-Al₂O₃) is preferably produced: T=830° C. to 950° C., p<1 bar (=10⁵ Pa), t=2-4 h, in order to produce the desired aluminum oxide.

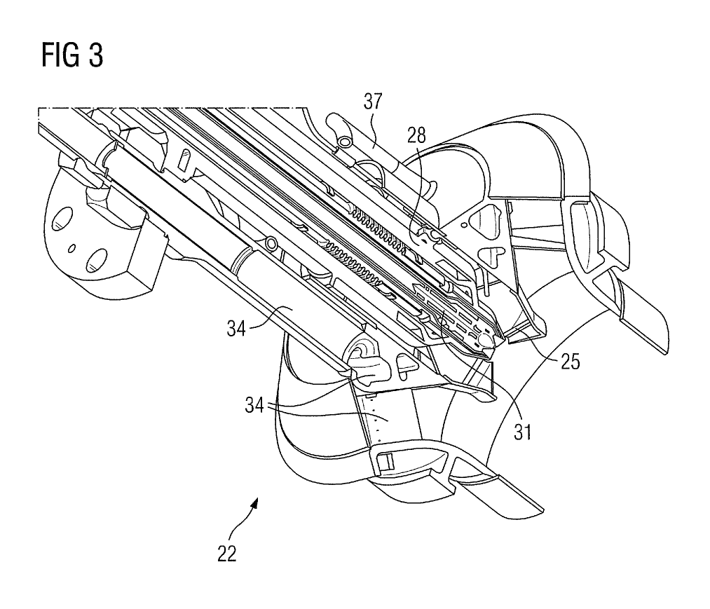

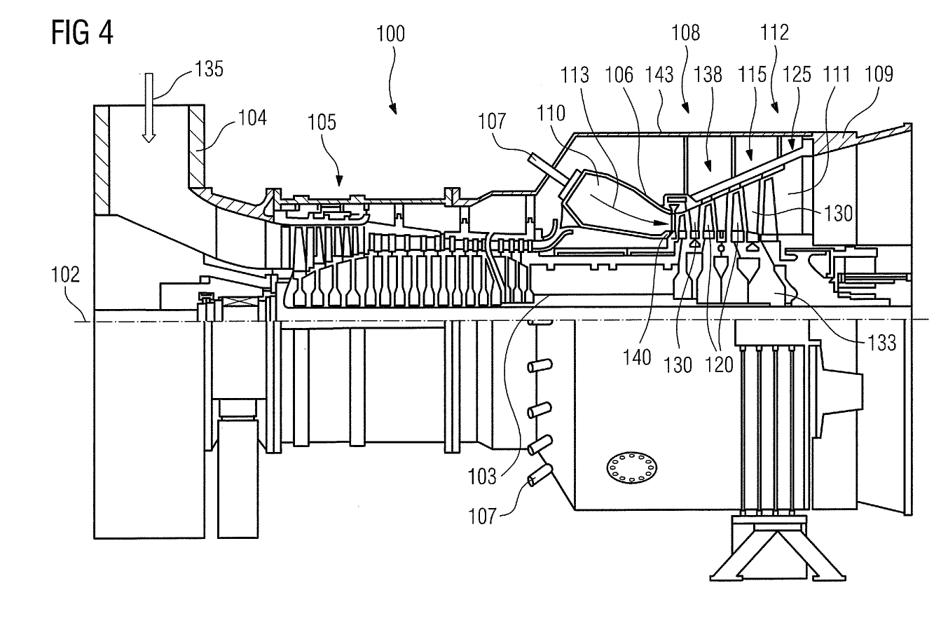

This thin, high-temperature-stable aluminum oxide layer 10 contributes to the corrosion or oxidation resistance of the component 1. Such a corrosion-resistant product may be used, for example, in burners 22 (FIG. 3) for gas turbines 100 (FIG. 4).

FIG. 3 shows a burner 22 having an axial swirler 25 (preferably made from Hastelloy X), a burner connection piece 28 (preferably made from 16Mo13), the burner nozzle 31 (X6CrNiMoTi17-12-2), a diagonal swirler 34 for gas (16Mo3) and a diagonal swirler 37 (X6CrNiMoTi12-2) for oil.

In the case of a burner 22, the X6CrNiMoTi17-12-2 and Hastelloy X materials can also be alitized/chromized and/or oxidized within the meaning of the invention.

The process is particularly suitable for coating the inside of fuel-conducting passages: fuel feed, hub, burner carrier, diagonal cascade blades or vanes.

In this case, the inner surfaces of the nozzles and/or swirlers are alitized and/or chromized and also pre-oxidized.

FIG. 4 shows, by way of example, a partial longitudinal section through a gas turbine 100.

In the interior, the gas turbine 100 has a rotor 103 with a shaft which is mounted such that it can rotate about an axis of rotation 102 and is also referred to as the turbine rotor.

An intake housing 104, a compressor 105, a, for example, toroidal combustion chamber 110, in particular an annular combustion chamber, with a plurality of coaxially arranged burners 107, a turbine 108 and the exhaust-gas housing 109 follow one another along the rotor 103.

The annular combustion chamber 110 is in communication with a, for example, annular hot-gas passage 111, where, by way of example, four successive turbine stages 112 form the turbine 108.

Each turbine stage 112 is formed, for example, from two blade or vane rings. As seen in the direction of flow of a working medium 113, in the hot-gas passage 111 a row of guide vanes 115 is followed by a row 125 formed from rotor blades 120.

The guide vanes 130 are secured to an inner housing 138 of a stator 143, whereas the rotor blades 120 of a row 125 are fitted to the rotor 103 for example by means of a turbine disk 133.

A generator (not shown) is coupled to the rotor 103.

While the gas turbine 100 is operating, the compressor 105 sucks in air 135 through the intake housing 104 and compresses it. The compressed air provided at the turbine-side end of the compressor 105 is passed to the burners 107, where it is mixed with a fuel. The mix is then burnt in the combustion chamber 110, forming the working medium 113. From there, the working medium 113 flows along the hot-gas passage 111 past the guide vanes 130 and the rotor blades 120. The working medium 113 is expanded at the rotor blades 120, transferring its momentum, so that the rotor blades 120 drive the rotor 103 and the latter in turn drives the of the working medium 113, together with the heat shield elements which line the annular combustion chamber 110, are subject to the highest thermal stresses. To be able to withstand the temperatures which prevail there, they may be cooled by means of a coolant. Substrates of the components may likewise have a directional structure, i.e. they are in single-crystal form (SX structure) or have only longitudinally oriented grains (DS structure). By way of example, iron-based, nickel-based or cobalt-based superalloys are used as material for the components, in particular for the turbine blade or vane 120, 130 and components of the combustion chamber 110.

Superalloys of this type are known, for example, from EP 1 204 776 B1, EP 1 306 454, EP 1 319 729 A1, WO 99/67435 or WO 00/44949.

The guide vane 130 has a guide vane root (not shown here), which faces the inner housing 138 of the turbine 108, and a guide vane head which is at the opposite end from the guide vane root. The guide vane head faces the rotor 103 and is fixed to a securing ring 140 of the stator 143.

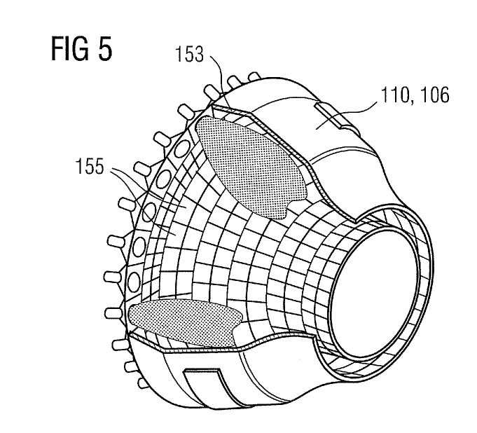

FIG. 5 shows a combustion chamber 110 of the gas turbine 100. The combustion chamber 110 is configured, for example, as what is known as an annular combustion chamber, in which a multiplicity of burners 107, which generate flames 156, arranged circumferentially around an axis of rotation 102 open out into a common combustion chamber space 154. For this purpose, the combustion chamber 110 overall is of annular configuration positioned around the axis of rotation 102.

To achieve a relatively high efficiency, the combustion chamber 110 is designed for a relatively high temperature of the working medium M of approximately 1000° C. to 1600° C. To allow a relatively long service life even with these operating parameters, which are unfavorable for the materials, the combustion chamber wall 153 is provided, on its side which faces the working medium M, with an inner lining formed from heat shield elements 155.

Moreover, a cooling system may be provided for the heat shield elements 155 and/or their holding elements, on account of the high temperatures in the interior of the combustion chamber 110. The heat shield elements 155 are then, for example, hollow and may also have cooling holes (not shown) opening out into the combustion chamber space 154.

On the working medium side, each heat shield element 155 made from an alloy is equipped with a particularly heat-resistant protective layer (MCrAlX layer and/or ceramic coating) or is made from material that is able to withstand high temperatures (solid ceramic bricks).

These protective layers may be similar to the turbine blades or vanes, i.e. for example MCrAlX: M is at least one element selected from the group consisting of iron (Fe), cobalt (Co), nickel (Ni), X is an active element and stands for yttrium (Y) and/or silicon and/or at least one rare earth element or hafnium (Hf). Alloys of this type are known from EP 0 486 489 B1, EP 0 786 017 B1, EP 0 412 397 B1 or EP 1 306 454 A1.

It is also possible for a, for example, ceramic thermal barrier coating to be present on the MCrAlX, consisting for example of ZrO₂, Y₂O₃—ZrO₂, i.e. unstabilized, partially stabilized or fully stabilized by yttrium oxide and/or calcium oxide and/or magnesium oxide.

Columnar grains are produced in the thermal barrier coating by suitable coating processes, such as for example electron beam physical vapor deposition (EB-PVD).

Other coating processes are possible, e.g. atmospheric plasma spraying (APS), LPPS, VPS or CVD. The thermal barrier coating may include grains that are porous or have micro-cracks or macro-cracks, in order to improve the resistance to thermal shocks

Refurbishment means that after they have been used, protective layers may have to be removed from turbine blades or vanes 120, 130 and heat shield elements 155 (e.g. by sand-blasting). Then, the corrosion and/or oxidation layers and products are removed. If appropriate, cracks in the turbine blade or vane 120, 130 or in the heat shield element 155 are also repaired. This is followed by recoating of the turbine blades or vanes 120, 130 and heat shield elements 155, after which the turbine blades or vanes 120, 130 or the heat shield elements 155 can be reused.

While the gas turbine 100 is operating, the components which are exposed to the hot working medium 113 are subject to thermal stresses. The guide vanes 130 and rotor blades 120 of the first turbine stage 112, as seen in the direction of flow

1.-33. (canceled)

34. A corrosion-resistant pressure vessel steel product, comprising:
a substrate comprising a pressure vessel steel which is alitized,
wherein before the substrate is used for the first time and after the alitizing, the substrate is oxidized and thereby includes an oxide layer.

35. The pressure vessel steel product as claimed in claim 35, wherein the substrate comprises iron, carbon, manganese, molybdenum and aluminum.

36. The pressure vessel steel product as claimed in claim 35, wherein the substrate includes a material selected from the group consisting of silicon, phosphorus, sulfur, copper, and combinations thereof.

37. The pressure vessel steel product as claimed in claim 35, wherein the substrate includes the material 16Mo3.

38. The pressure vessel steel product as claimed in claim 35, wherein the substrate includes chromium.

39. The pressure vessel steel product as claimed in claim 35, wherein the substrate includes molybdenum.

40. The pressure vessel steel product as claimed in claim 35, wherein the substrate includes vanadium.

41. The pressure vessel steel product as claimed in claim 37, further comprising silicon, and
wherein a maximum content of silicon is 0.35% by weight.

42. The pressure vessel steel product as claimed in claim 37 further comprising phosphorus, and
wherein the maximum content of phosphorus is 0.35% by weight.

43. The pressure vessel steel product as claimed in claim 37, further comprising sulfur, and
wherein the maximum content of sulfur is 0.3% by weight.

44. The pressure vessel steel product as claimed in claim 37, further comprising copper, and
wherein the maximum content of copper is 0.3% by weight.

45. The pressure vessel steel product as claimed in claim 39, wherein the chromium and/or the aluminum also form an overlay layer.

46. The pressure vessel steel product as claimed in claim 35, further comprising a material selected from the group consisting of silicon, cerium, hafnium, zirconium and any combinations thereof.

47. The pressure vessel steel product as claimed in claim 38, wherein the chromium and/or the aluminum form a pure diffusion layer.

48. A process for producing a corrosion-resistant pressure vessel steel product, alitizing a pressure vessel steel; and
oxidizing the pressure vessel steel before the pressure vessel steel is used for a first time.

49. The process as claimed in claim 48, wherein the pressure vessel steel used is 16Mo3.

50. The process as claimed in claim 48, wherein only an alitizing is carried out.

51. The process as claimed in claim 48, wherein a CVD process is used for the alitizing.

52. A gas turbine component, comprising:
a pressure vessel steel product, comprising:
a substrate comprising a pressure vessel steel which is alitized,
wherein the pressure vessel steel product is produced by alitizing and then oxidizing the pressure vessel steel before the pressure vessel steel is used for a first time.

53. The gas turbine component as claimed in claim 52, wherein the gas turbine component is a part of a burner.
